(19) United States
(12) Patent Application Publication
(10) Pub. No.: US 2006/0083435 A1
(43) Pub. Date: Apr. 20, 2006

(54) Apparatus and method for calculating the prediction value of the high frequency and low frequency components of an image

(75) Inventor: Fu-Chung Chi, Taipei (TW)

Correspondence Address: BIRCH STEWART KOLASCH & BIRCH, PO BOX 747, FALLS CHURCH, VA, 22040-0747, US

(73) Assignee: Ali Corporation

(21) Appl. No.: 11/062,434

(22) Filed: Feb. 23, 2005

(30) Foreign Application Priority Data
Oct. 19, 2004 (TW) 93131646

(51) Int. Cl. G06K 9/36

(52) U.S. Cl. 382/238

(57) ABSTRACT

An apparatus and method is provided for calculating the prediction value of the high frequency and low frequency components of a MPEG4 or DivX image format. The apparatus comprises a prediction parameter table, a look-up table parameter calculation circuit, a multiplier, a control circuit, and an adder. The present apparatus uses a simple and low-cost structure to decode more efficiently the prediction value of the high frequency and low frequency components of an image in MPEG4 and DivX format.

### BACKGROUND OF THE INVENTION

1. Field of the Invention

The present invention relates to an apparatus and method for calculating the prediction value of the high frequency and low frequency components of an image. In particular, this invention provides an apparatus and method for calculating the prediction value of the high frequency and low frequency components of an image in MPEG4 and DivX format.

2. Description of the Related Art

In MPEG4 and DivX encoding format, there are specific similarities in the high frequency and low frequency components of an image between the neighbor blocks. By utilizing these similar characteristics and differential pulse code modulation, the quantity of the compressed bit stream encoding can be significantly reduced. According to the decoding specifications of MPEG4 and DivX, it includes the following steps. Firstly, calculating the difference values of high frequency and low frequency components of the block. Secondly, finding out the prediction value from the above and the remaining blocks. After ascertaining the prediction values, the prediction values of high frequency and low frequency components of the block can be calculated by the following formula:

For the prediction value of low frequency components of the block:
QFx[0][0]=PQFx[0][0]+Fc[0][0]//dc_scaler

For the prediction value of high frequency components of the block:
QFx[v][0]=PQFx[v][0]+Qfa[v][0]*Qpa//QPx(for v=1 to 7)
QFx[0][u]=PQFx[0][u]+Qfc[0][u]*Qpc//QPx(for u=1 to 7)

In the above formulas, PQFx[0][0] is the difference value after decoding. Fc[0][0] is the prediction value multiplying a low frequency enlarging coefficient (dc_scaler). The low frequency enlarging coefficient is decided by the quantification value that comes from the decoding of the macro block.

Please refer to FIG. 1, which shows the prior art method for calculating the prediction value of the high frequency and low frequency components of an image. Firstly, the parameter table 14 is multiplied by the parameter table 16 by using a multiplier circuit 10. The result of multiplier circuit 10 is then divided by the parameter 18 by a division circuit 12. Moreover, the specifications of MPEG4 and DivX, the precision of the PQFx[v][0] and PQFx[0][u] have to be between −2048 to 2048. Therefore, the precision of the PQFx[v][0] and PQFx[0][u] is 12 bits. So, if we use a division circuit for calculating the prediction value of the high frequency and low frequency components, twelve cycles are needed. Furthermore, the above calculation needs to be applied to a single block one time to obtain the prediction value of the low frequency. To obtain the prediction value of the high frequency it must applied seven times. All together, 96 cycles are needed for calculating the prediction value of the high frequency and low frequency components of one block. Furthermore, 576 cycles are needed for calculating the prediction value of the high frequency and low frequency components of one macro block. One macro block is comprised of six blocks. If we apply this prior art circuit to a HDTV, the decoding speed will be insufficient. However, if eight circuits of the prior art are used, it will substantially increase the cost.

Referring to FIG. 2, another prior apparatus for calculating the prediction value of the high frequency and low frequency components of an image is shown. This apparatus comprises a multiplier circuit 20, three parameter tables 37, 38 and 39, three multiplexers 22, 24 and 26, two registers 32 and 34, a look-up table 36, a subtracter 28 and a comparator 30. This circuit does not use a division circuit for division operation. The procedure begins when a corresponding value is selected from the look-up table 36 according to QPx. For example, if the value of QPx is 7 and the precision of QPx is 14 bits, the corresponding value in the look-up table is (2ˆ14+QPx/2)/QPx=2341. Then Qfa is multiplied by Qpa. Thirdly, the corresponding value from the look-up table 36 is multiplied by the result of Qfa multiplied by Qpa, and divided by 2ˆ14 to obtain a quotient. Finally, the quotient is multiplied by QPx, and the answer is subtracted from Qfa*Qpa. The answer obtained is the remainder. If twice the remainder is bigger than or equal to QPx, one needs to be added to the quotient. Otherwise, the answer is the calculated quotient.

For the procedure described above, a total of 32 cycles is needed for calculating the prediction value of the high frequency and low frequency components of one block. 192 cycles are needed for calculating the prediction value of the high frequency and low frequency components of one macro block. The number of cycles required is still many and the control circuits required are highly complex. If we apply this prior circuit to a HDTV, the decoding efficiency is still insufficient.

### SUMMARY OF THE INVENTION

The main purpose of the present invention is to provide an apparatus and method for calculating the prediction value of the high frequency and low frequency components of an image in MPEG4 and DivX format. The present apparatus can use a simple and low-cost structure to decode more efficiently the prediction value of the high frequency and low frequency components of an image in MPEG4 and DivX format.

In order to achieve the above goal, the present invention provides an apparatus for calculating the prediction value of the high frequency and low frequency components of an image. The apparatus comprises a prediction parameter table for inputting a first parameter, a look-up table parameter calculation circuit for calculating and saving a second parameter and a third parameter, a multiplier connecting to the prediction parameter table and a look-up table parameter calculation circuit for multiplying the first parameter with the result of the look-up table parameter calculation circuit, a control circuit connecting to the multiplier for rounding off and compensating for any calculating errors, and an adder connecting to the multiplier and the control circuit for adding the output of the multiplier and the output of the control circuit.

The present invention also provides a method for calculating the prediction value of the high frequency and low frequency components of an image. The steps comprises:

building a parameter look-up table, the table value is built according to the specifications of the prediction value of the high frequency and low frequency components of an image;

multiplying the table value of the parameter look-up table with another parameter.

compensating the result of the multiplication by rounding off;

adding the result of the multiplication and the result of rounding off to get the prediction value of the high frequency and low frequency components of an image.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a circuit diagram of a conventional apparatus for calculating the prediction value of the high frequency and low frequency components of an image;

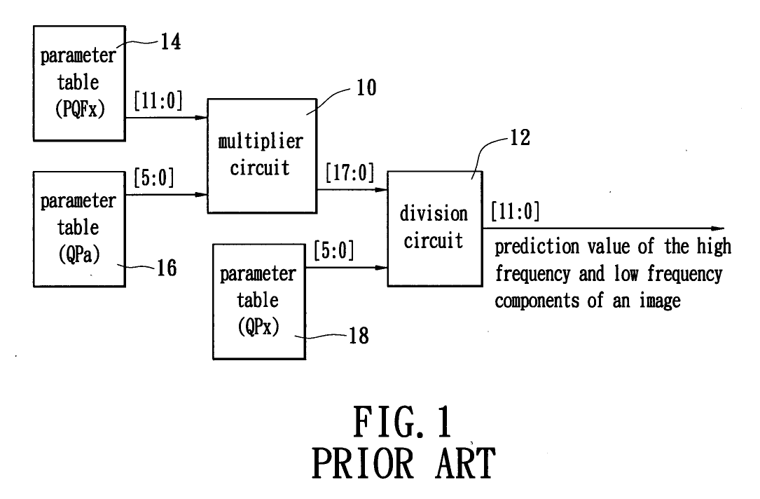

FIG. 2 is a circuit diagram of another conventional apparatus for calculating the prediction value of the high frequency and low frequency components of an image;

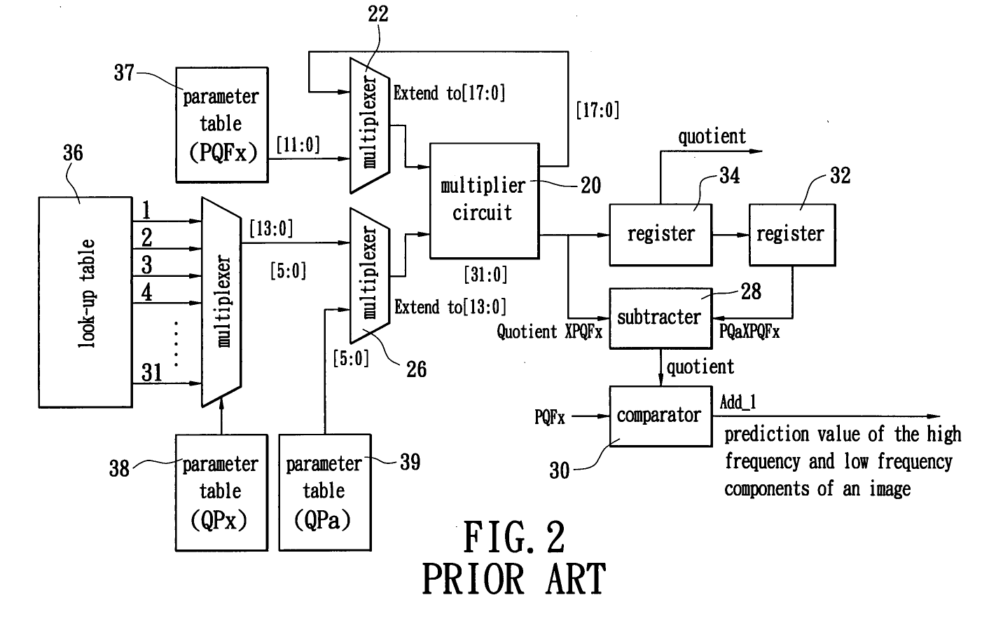

FIG. 3 is a statistical diagram of lose-truth remainder of the present apparatus for calculating the prediction value of the high frequency and low frequency components of an image;

FIG. 4A is a statistical diagram of a look-up table value of the present apparatus for calculating the prediction value of the high frequency and low frequency components of an image;

FIG. 4B is a statistical diagram of a look-up table value of the present apparatus for calculating the prediction value of the high frequency and low frequency components of an image;

FIG. 5 is a circuit diagram of the present apparatus for calculating the prediction value of the high frequency and low frequency components of an image; and

FIG. 6 is a flow chart of the present apparatus for calculating the prediction value of the high frequency and low frequency components of an image.

### DETAILED DESCRIPTION OF THE PREFERRED EMBODIMENTS

The present invention provides an apparatus for calculating the prediction value of the high frequency and low frequency components of an image. The present apparatus uses a multiplication/division operation to replace the prior multiplier and division circuit. The present apparatus can substantially reduce the calculation time and the cost of the circuit. According to the specifications, we need to multiply a first parameter with a second parameter, and divide the answer by a third parameter. The formula can be simplified as a prediction value (pred_value) equal to the first parameter (coef) multiplied by the second parameter (A), and divided by the third parameter (B), i.e. pred_value=coef*A/B. For the prediction value of the low frequency components of an image, the value of A and B is between 1 and 46. For the prediction value of the high frequency components of an image, the value of A and B is between 1 and 31. In mathematics, coef*A/B is same as coef*(A/B), i.e. Pred_value=coef*A/B=coef*(A/B). Therefore, if we pre-calculate the value of A/B and save it as a table, it just needs to be multiplied to obtain the prediction value of the high frequency and the low frequency components of an image.

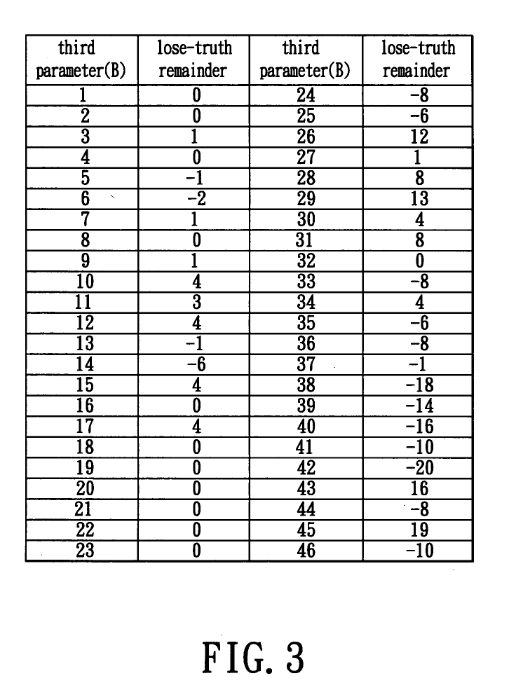

FIG. 3 is a statistical diagram of lose-truth remainder of the third parameter basis on a precision with 18 bits. The first column and the third column contain the value of the third parameter (B), ranging from 1 to 16. The second column and the forth column contain the lose-truth remainder (LT_R). The formula is LT_R=2ˆ18−tab[B]* B,tab[B]=(2ˆ18+(B/2))/B.

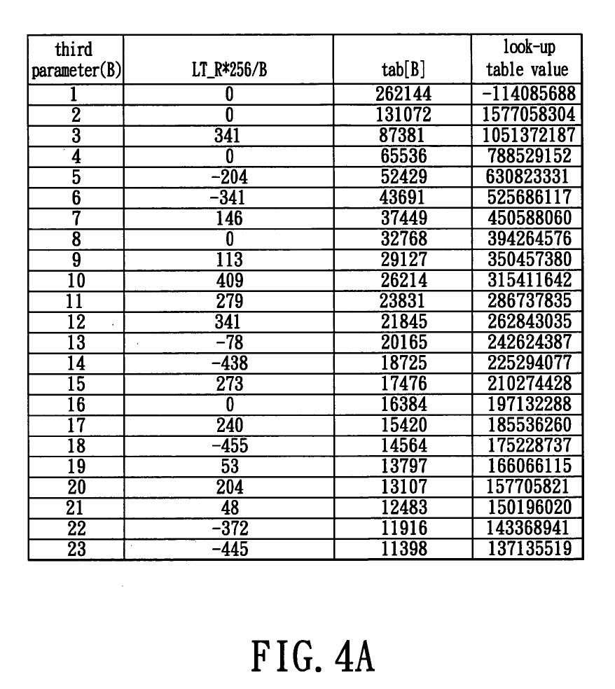

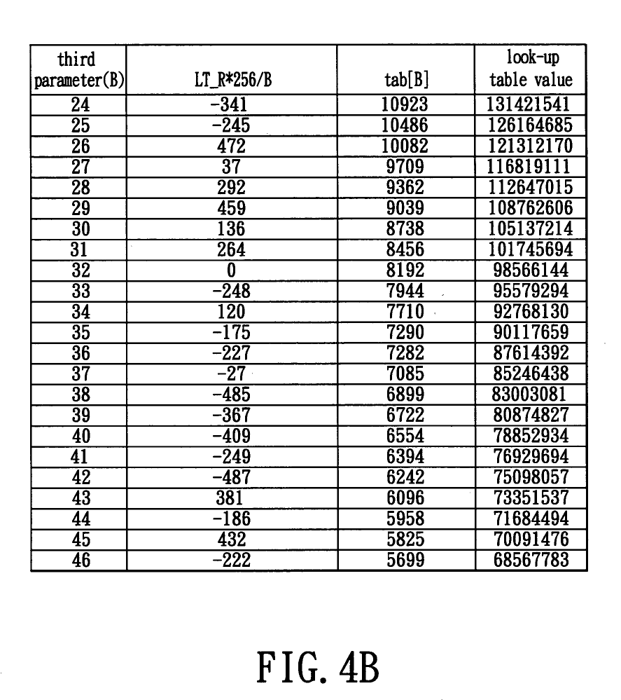

In order to obtain the precision requirement of the prediction value of the high frequency and the low frequency components of an image in MPEG4 and DivX format, we need to amplify the lose-truth remainder 256 times and build a look-up table relating to the third parameter. Please refer to FIG. 4A and FIG. 4B. The first column contains the value of the third parameter (B). The second column contains the lose-truth remainder amplifies 256 times, and divided by the third parameter (B). The third column contains the table value of the third parameter (tab[B]). The fourth column contains the look-up table value built by the present invention with a basis of the third parameter (B), having 46 sets in total. The formula is tab[B]*256+LT_R*256/B.

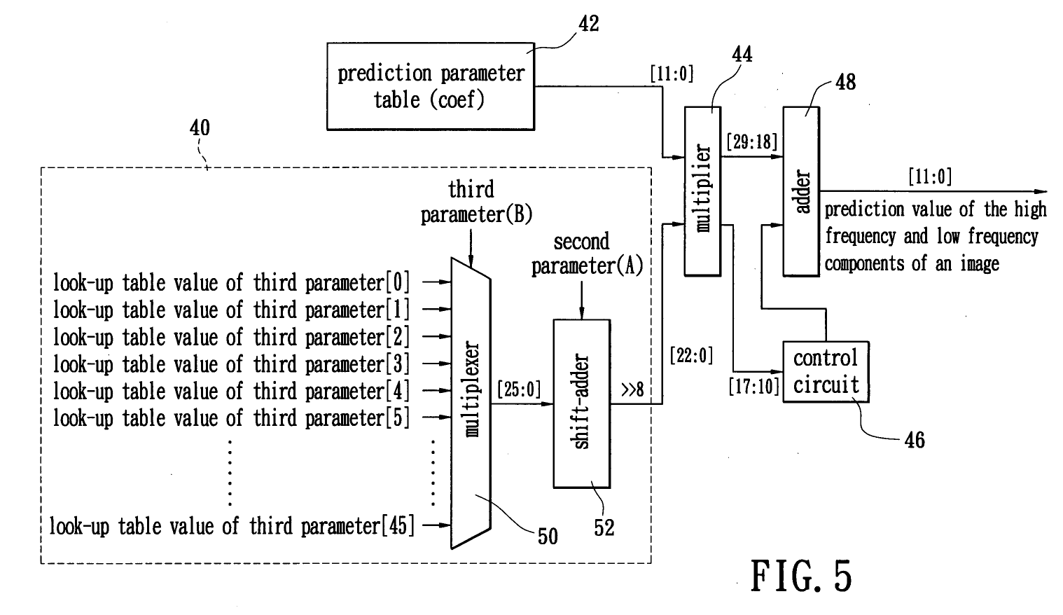

FIG. 5 shows an apparatus for calculating the prediction value of the high frequency and low frequency components of an image. The present apparatus comprises a prediction parameter table 42 for inputting a first parameter (coef), a look-up table parameter calculation circuit 40 for calculating and saving a second parameter (A) and a third parameter (B). The look-up table parameter calculation circuit 40 further comprises a multiplexer 50, the input of the multiplexer 50 is a look-up table value built by the third parameter (B) as a basis, having a total of 46 sets (see the fourth column of FIG. 4), and a shift-adder 50 connected to the multiplexer 50 for operating the output of the multiplexer 50 and a second parameter (A). The function of the shift-adder is equal to multiplying the output of the multiplexer 50 with the second parameter. The number of the input of the multiplexer 50 is 46. In the calculation, the value needs to be amplified 256 times in order to compensate for the calculated lose-truth remainder. The bit number of the output of the multiplexer 50 is 26 to match with the precise requirements of the prediction value of the high frequency and low frequency components of an image. The shift-adder 52 will shift the result to the right with 8 bits, by dividing the result by 256, to recover the value.

The present apparatus for calculating the prediction value of the high frequency and low frequency components of an image also comprises of a multiplier 44 connecting to the prediction parameter table 42 and the look-up table parameter calculation circuit 40 for multiplying the first parameter with the result of the look-up table parameter calculation circuit 40 (the bit number of the multiplier 44 is 35), a control circuit 46 connecting to the multiplier 44 for rounding off and compensating for calculating errors, the control circuit 46 uses the tenth to seventeenth bit of output of the multiplier 44 to perform the rounding off operation, and an adder 48 connecting to the multiplier 44 and the control circuit 46 for adding the output of the multiplier 44 and the output of the control circuit 46.

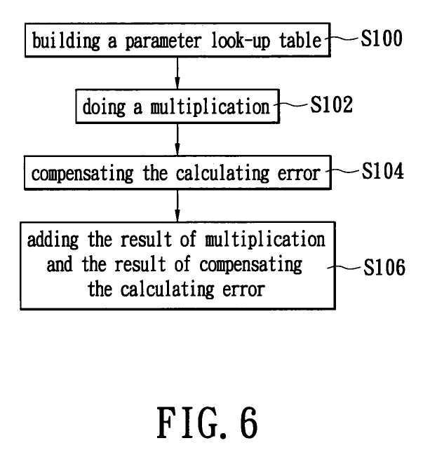

FIG. 6 shows a flow chart of the method for calculating the prediction value of the high frequency and low frequency components of an image. The process comprises of the following steps:

building a parameter look-up table (S100), the table value is built according to the specifications of the prediction value of the high frequency and low frequency components of an image for calculating and saving the second parameter and the third parameter. The formula is (tab[B]*256+LT_R*256/B)*A. In the calculation, the value needs to be amplified 256 times in order to compensate for the calculating lose-truth remainder. The bit number of the parameter look-up table is 26 for fitting in with the precise requirements of the prediction value of the high frequency and low frequency components of an image. The output value of the parameter look-up table needs to be divided by 256 to recover the value.

doing a multiplication (S102), this means multiplying the table value of the parameter look-up table with a first parameter. The bit number for multiplication is 35.

compensating for the calculating error (S104) by rounding off the result of the multiplication in (S102). Only the tenth to seventeenth bits of the result of the multiplication are used by the process of compensating for calculating errors by the rounding off operation. When the prediction value is positive and the seventeenth bit is 1, or the third parameter is odd and the seventeenth to eleventh bit is 0111111, or the prediction value is negative and the seventeenth bit is 1 or the seventeenth to eleventh bit is 0111111, the result is 1. The other output is 0. Add the result of the multiplication and the result of compensating for the calculating error to get the prediction value of the high frequency and low frequency components of an image (S106).

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An apparatus for calculating the prediction value of the high frequency and low frequency components of an image, comprising:
a prediction parameter table, for inputting a first parameter;
a look-up table parameter calculation circuit, for calculating and saving a second parameter and a third parameter;
a multiplier, connecting to the prediction parameter table and the look-up table parameter calculation circuit, for multiplying the first parameter with the result of the look-up table parameter calculation circuit;
a control circuit, connecting to the multiplier, for doing a round off operation on the output of the multiplier and compensating the calculating error; and
an adder, connecting to the multiplier and the control circuit, for adding the output of the multiplier and the output of the control circuit to get the prediction value of the high frequency and low frequency components of an image.

2. The apparatus for calculating the prediction value of the high frequency and low frequency components of an image of claim 1, wherein the bit number of the multiplier is 35.

3. The apparatus for calculating the prediction value of the high frequency and low frequency components of an image of claim 1, wherein the control circuit doing a rounding off operation only needs to use the tenth to seventeenth bit of the output of the multiplier, for a total of 8 bits.

4. The apparatus for calculating the prediction value of the high frequency and low frequency components of an image of claim 1, wherein the look-up table parameter calculation circuit further comprises:
a multiplexer, the input of the multiplexer is a look-up table value built using the third parameter(B) as a base; and
a shift-adder, connecting to the multiplexer for operating the output of the multiplexer and the second parameter, the function of the shift-adder is equal to multiplying the output of the multiplexer with the second parameter.

5. The apparatus for calculating the prediction value of the high frequency and low frequency components of an image of claim 4, wherein the input of the multiplexer is a look-up table value built by the third parameter with a precision of 18 bits and adding a lose-truth remainder to compensate for calculation errors. In the calculation, the value needs to be amplified 256 times in order to compensate for the calculation lose-truth remainder.

6. The apparatus for calculating the prediction value of the high frequency and low frequency components of an image of claim 4, wherein the number of the input of the multiplexer is 46.

7. The apparatus for calculating the prediction value of the high frequency and low frequency components of an image of claim 4, wherein the number of the output of the multiplexer is 26.

8. The apparatus for calculating the prediction value of the high frequency and low frequency components of an image of claim 4, wherein the shift-adder will shift the result to the right with 8 bits, by dividing the result by 256, to recover the value.

9. A method for calculating the prediction value of the high frequency and low frequency components of an image, comprising:
building a parameter look-up table, the table value is built according to the specifications of the prediction value of the high frequency and low frequency components of an image for calculating and saving the second parameter and the third parameter;
doing a multiplication, this means multiplying the table value of the parameter look-up table with a first parameter;
compensating for the calculating error, doing a rounding off calculation on the result of the multiplication; and
adding the result of the multiplication and the result of compensating for the calculating error to get the prediction value of the high frequency and low frequency components of an image.

10. The method for calculating the prediction value of the high frequency and low frequency components of an image of claim 9, wherein the building a parameter look-up table needs to be amplified 256 times in order to compensate for the calculated lose-truth remainder in the calculation.

11. The method for calculating the prediction value of the high frequency and low frequency components of an image of claim 9, wherein the bit number of the parameter look-up table is 26 to match the precise requirements of the prediction value of the high frequency and low frequency components of an image.

12. The method for calculating the prediction value of the high frequency and low frequency components of an image of claim 9, wherein the output value of the parameter look-up table needs to be divided by 256 to recover the value.

13. The method for calculating the prediction value of the high frequency and low frequency components of an image of claim 9, wherein the bit number for multiplication is 35.

14. The method for calculating the prediction value of the high frequency and low frequency components of an image of claim 9, wherein only the tenth to seventeenth bits of the result of the multiplication are used by the process of compensating for calculating errors of the rounding off operation. When the prediction value is positive and the seventeenth bit is 1, or the third parameter is odd and the seventeenth to eleventh bit is 0111111, or the prediction value is negative and the seventeenth bit is 1 or the seventeenth to eleventh bit is 0111111, the result is 1. The other output is 0.
